(19) United States
(12) Patent Application Publication
(10) Pub. No.: US 2017/0043638 A1
(43) Pub. Date: Feb. 16, 2017

(54) LEAF SPRING VIBRATION DAMPENING PAD

(71) Applicant: Toyota Motor Engineering & Manufacturing North America, Inc., Erlanger, KY (US)

(72) Inventors: Dale K. Dyer, Chelsea, MI (US); Aria Kashani, Ann Arbor, MI (US)

(21) Appl. No.: 14/822,984

(22) Filed: Aug. 11, 2015

(51) Int. Cl. B60G 11/38

(52) U.S. Cl. CPC B60G 11/38; B60G 2202/14; B60G 2202/112; B60G 2206/42

(57) ABSTRACT

A leaf spring for a vehicle. The vehicle has a drivetrain that generates a high frequency vibration that is transmitted into an interior compartment of the vehicle and has a volume that can be heard by a driver and/or passenger. The leaf spring has a primary leaf and a secondary leaf that extends along and underneath the primary leaf. The leaf spring also has a high frequency dampener that is located between the primary and secondary leafs and is spaced apart from a tip liner insert. The high frequency dampener reduces the volume of a high frequency vibration that is present in the interior of the vehicle to a value less than an objectionable level to an occupant during operation of the vehicle. Therefore, the high frequency vibration is not heard by the driver and/or occupant.

### FIELD OF THE INVENTION

The present invention is related to a leaf spring, and in particular to a leaf spring with a vibration dampening pad that dampens high frequency vibration generated from a powertrain and transmitted to an interior of a vehicle.

### BACKGROUND OF THE INVENTION

Vehicles such as trucks, trailers, and the like that use leaf springs as part of a suspension system are known. In addition, some of these vehicles have a powertrain that includes a transmission, differential, etc. that affords for power generated by an internal combustion engine to be transmitted to wheels of the vehicle such that the vehicle can move along a surface. Such powertrains typically include a plurality of gears, belts, and the like, which upon operation of the vehicle can result in the generation of vibration. In addition, since the drivetrain is typically mechanically coupled to the remainder of the vehicle, the vibration can be transmitted to other components thereof such as a frame of the vehicle and an interior compartment of the vehicle.

One example of a powertrain vibration can occur when a pickup truck is driving along a highway at speeds such as 40 miles per hour, 50 miles per hour, 60 miles per hour, etc. In addition, the vibration can be a high frequency vibration that is transmitted through one or more axles of the pickup truck, one or more leaf springs that couple the axle to a frame of the pickup truck, to the frame, and then into an interior, sometimes known as a cab. Furthermore, the high frequency vibration can be present at a volume such that an occupant of the pickup truck can hear a high pitch noise or tone. Therefore, a leaf spring that affords for the dampening of the high pitch noise to a level such that the occupant no longer hears this high pitch tone would be desirable.

### SUMMARY OF THE INVENTION

A leaf spring for a vehicle is provided. The vehicle can have a drivetrain, also known as a powertrain, that generates a high frequency vibration that is transmitted into an interior compartment of the vehicle. In addition, the high frequency vibration has a volume that is objectionable to an occupant during operation of the vehicle.

The vehicle has a leaf spring that couples an axle of the drivetrain to a frame of the vehicle. The leaf spring has a primary leaf and a secondary leaf that extends along and underneath the primary leaf. The primary leaf and the secondary leaf are mechanically coupled to the axle of the vehicle at a generally central location of the leaf spring.

The leaf spring also includes a tip liner insert that is spaced apart from the central location of the leaf spring and is located between the primary leaf and the secondary leaf. The tip liner insert can be present in order to reduce friction between the primary leaf and the secondary leaf during operation of the vehicle. A high frequency dampener is also included and is spaced apart from the tip liner insert and located between the primary leaf and the secondary leaf. In addition, the tip liner insert is located between the high frequency dampener and the center location of the leaf spring. Stated differently, the high frequency dampener is located outwardly from the tip liner insert. Furthermore, the high frequency dampener reduces the volume of the high frequency vibration that is present in the interior to a level that is not objectionable and/or noticeable to the occupant during operation of the vehicle.

The primary leaf and the secondary leaf each have a front end and a rear end that face a front and a rear of the vehicle, respectively. In addition, the high frequency dampener is located between the primary leaf and secondary leaf front ends and the tip liner insert. The high frequency dampener can be attached to the secondary leaf and not be attached to the primary leaf. The high frequency dampener can be attached to the secondary leaf with a fastener such as a threaded fastener, an adhesive, a snap fastener, an interference fit type of fastener, a hook-and-loop fastener, etc. In some instances, the fastener is a snap fastener with a shaft and the secondary leaf has an aperture therethrough that is dimensioned for the shaft to slide therethrough. In this manner, a leaf spring that dampens or isolates high frequency vibration from a powertrain of the vehicle such that it is not heard by an occupant within an interior of the vehicle is provided.

### BRIEF DESCRIPTION OF THE DRAWINGS

FIG. 1 is a schematic illustration of a top view of a vehicle with a drivetrain and a frame;

FIG. 2 is a schematic illustration of a drivetrain that includes an axle, a leaf spring, and a frame mechanically coupled to an interior of a vehicle, the interior of the vehicle having an occupant ear level;

FIG. 3 is a side view of a leaf spring according to an aspect disclosed herein;

FIG. 4 is an exploded perspective view of a portion of the leaf spring shown in FIG. 3 and illustrating a high frequency dampener; and

FIG. 5 is a graphical plot of volume of sound versus frequency at an occupant ear level within an interior of a vehicle traveling at a predetermined speed along a highway with and without different types of high frequency dampeners in a leaf spring of the vehicle according to an aspect disclosed herein.

### DETAILED DESCRIPTION OF THE INVENTION

A leaf spring for a vehicle is provided. The leaf spring affords for dampening of a high frequency vibration that is produced by a drivetrain and transmitted into an interior of the vehicle. In some instances, the leaf spring dampens the high frequency vibration using a high frequency dampener that is located between a pair of leafs of the leaf spring and spaced outwardly from a tip liner insert that is also located between the pair of leafs.

A measure, i.e. a volume, of the high frequency vibration within the interior of the vehicle without the use of the inventive leaf spring disclose herein is greater than an objectionable level for an occupant and thus can be heard by a driver or passenger riding in the vehicle. However, the inventive leaf spring reduces the high frequency vibration volume to less than the objectionable level through the use of the high frequency dampener. In this manner, the high frequency vibration volume is reduced to a level such that it is not heard by an occupant at an ‘occupant ear level’ within the interior of the vehicle. In addition, the inventive leaf spring reduces a volume of the high frequency vibration instead of shifting the frequency.

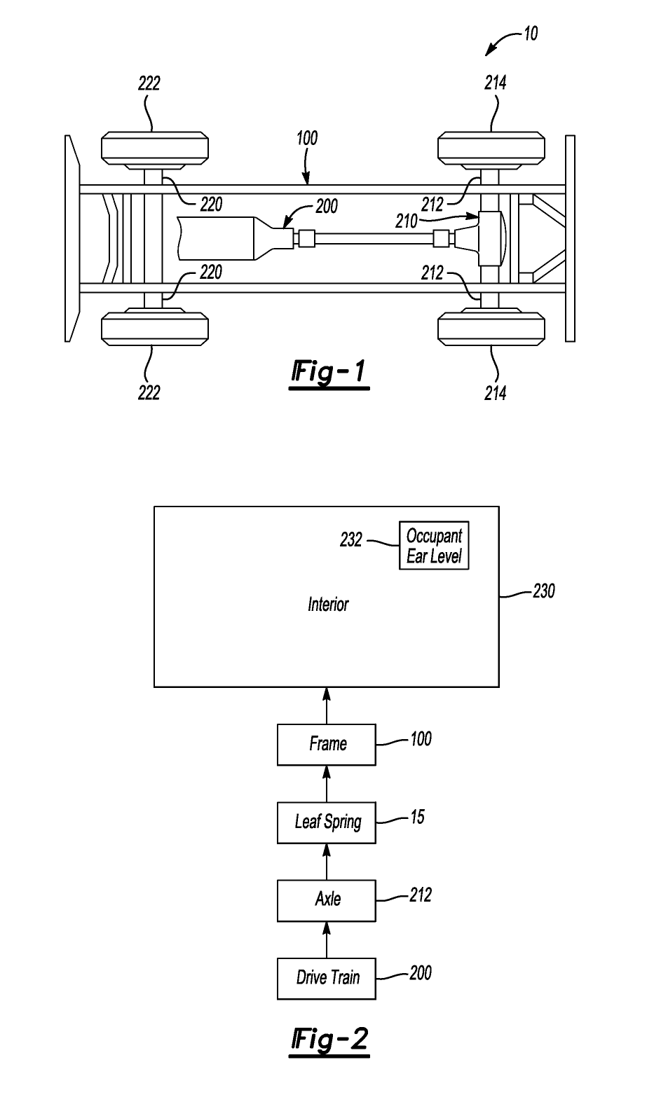

Turning now to FIG. 1, a schematic illustration of a top view of a motor vehicle that can use an inventive leaf spring disclosed herein is shown generally at reference numeral 10. The vehicle 10 has a frame 100 and a drivetrain 200. It is appreciated that the drivetrain 200 can include a transmission, one or more differential joints, an axle and the like. In particular, the drivetrain 200 includes an axle differential/gearbox 210 that is in mechanical connection with a rear axle 212 and one or more wheels or tires 214. It is appreciated that the drivetrain 200 affords for rotation of the tires 214 through the differential 210 and axle 212. The vehicle 10 can also include a front axle 220 with a pair of tires 222, and in the event that the vehicle is an all wheel drive vehicle or a four wheel drive vehicle, the drivetrain 200 can afford for the rotation of tires 222 as is known to those skilled in the art.

With respect to FIG. 2, the drivetrain 200 includes the axle 212, which is mechanically coupled to a leaf spring 15 at a central location as is known to those skilled in the art, e.g. using one or more U-bolts. The leaf spring 216 is mechanically coupled to the frame 100 and the frame 100 is mechanically coupled to an interior 230 of the vehicle 10. Within the interior 230 is an occupant ear level location 232. The occupant ear level 232 is the approximate location of the ears of an individual sitting within the interior 230.

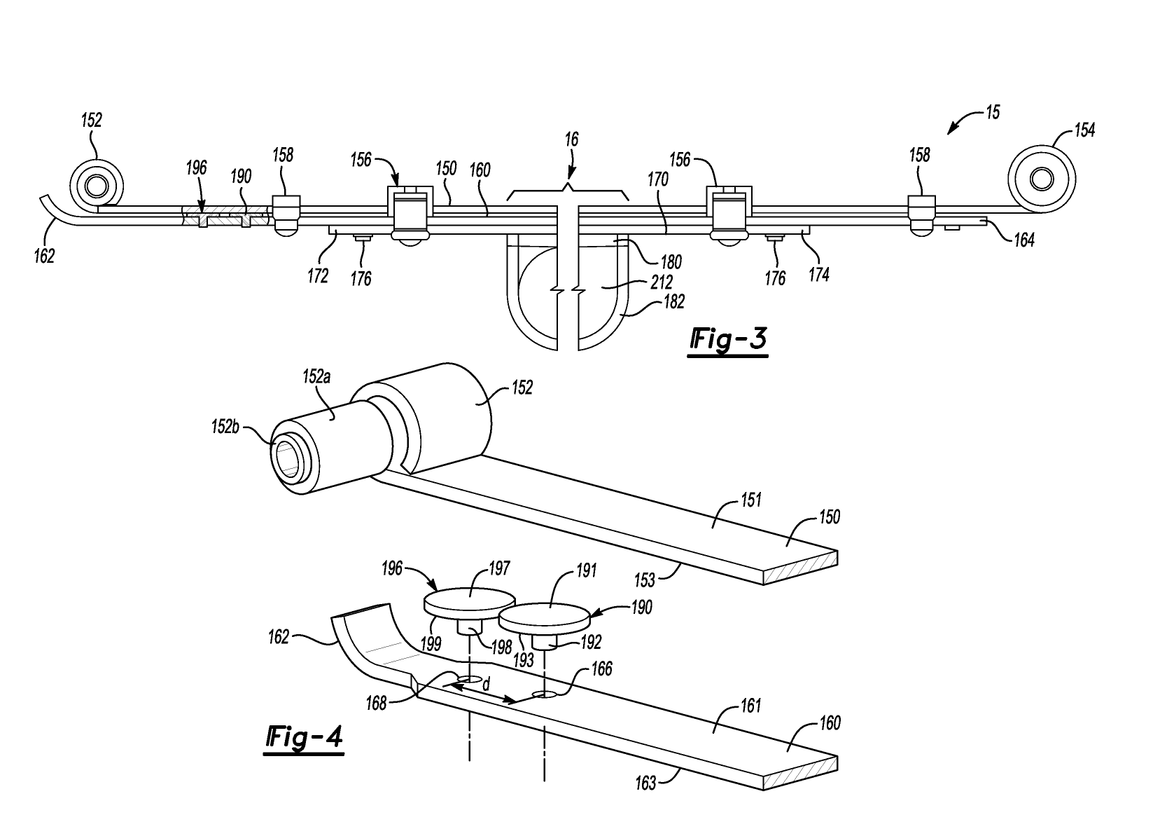

Turning now to FIG. 3, a side view of the leaf spring 15 according to an aspect disclosed herein is shown. The leaf spring 15 has a first or primary leaf 150 and a second or secondary leaf 160. The primary leaf 150 has a front eye ring 152 and a rear eye ring 154. It is appreciated that the front eye ring 152 is located towards or proximate to a front of the vehicle 10 and the rear eye ring 154 is located towards or proximate to a rear of the vehicle 10. The secondary leaf 160 also has a front end 162 which may or may not be in the form of a military wrap and a rear end 164. Optionally, a third leaf 170 which also has a front end 172 and a rear end 174 can be included.

The primary leaf 150, secondary leaf 160, and optional third leaf 170 can be held together and maintained in a proper position using a spring clip 156 as is known to those skilled in the art. In addition, the primary leaf 150 and secondary leaf 160 can be maintained in a proper position using a spring clip 158. It is appreciated that the spring clips assist the primary leaf in absorbing rebound vibrations from the other leafs and also prevent spreading or “fanning out” of the leafs. It is also appreciated that the leaf spring 15 has a central location 16 that is attached to the axle 212 using an axle plate 180 and one or more U-bolts 182 as is known to those skilled in the art.

FIG. 3 also illustrates a cutout section with a tip liner insert 190 and a high frequency dampener 196, both of which are located between the primary leaf 150 and secondary leaf 160. An enlarged perspective view of this cutout section is shown in FIG. 4. The primary leaf 150 has a top surface 151 and a bottom surface 153, and the eye ring 152 can have a first bushing insert 152a and a second bushing insert 152b. It is appreciated that the first bushing insert 152a can be made from a polymeric material to assist in vibration absorption, while the second bushing insert 152b can be made from a metallic material. It is further appreciated that a shaft such as a bolt can extend through the second bushing insert 152b which in turn connects a leaf spring shackle (not shown) which couples the eye ring 152 to the frame 100.

Extending along and below the primary leaf 150 is the secondary leaf 160 which has a top surface 161 and a bottom surface 163. The front end 162 can have a curvature and thus serve as a military wrap as is known to those skilled in the art. The secondary leaf 160 can have an aperture 166 which affords for a shaft 192 of the tip liner insert 190 to fit therewithin. The tip liner insert 190 has a top surface 191 and a bottom surface 193 which afford for sliding movement between the primary leaf 150 and the secondary leaf 160 during operation of the leaf spring 15. The secondary leaf 160 can also have an aperture 168 which is dimensioned for a shaft 198 of the high frequency dampener 196 to slide therethrough. The high frequency dampener 196 has a top surface 197 and a bottom surface 199. However, and unlike the tip liner insert 190, the high frequency dampener 196 dampens or reduces a volume of a high frequency vibration generated from the drivetrain 200, transmitted through the leaf spring 15, to the frame 100, and into the interior 230 of the vehicle.

A distance ‘d’ between the aperture 166 for the tip liner insert shaft 192 and the aperture 168 for the high frequency dampener shaft 198 is a predefined distance and is shown for illustrative purposes only in FIG. 4. Stated differently, the appearance of the tip liner insert 190 and the high frequency dampener 196 being relatively close together is not required and the actual distance ‘d’ can vary depending on a given vehicle model.

In one aspect disclosed herein, the high frequency dampener 196 is located outwardly from the tip liner insert 190, i.e. the high frequency dampener 196 is located further away from the axle pad 180 and/or one or more U-bolts 182 than the tip liner insert 190. Stated differently, the high frequency dampener 196 is located between the front end 152 of the primary leaf and the tip liner insert 190 and/or between the front end 162 of the secondary leaf and the tip liner insert 190. It is appreciated that the high frequency dampener 196 is attached to the secondary leaf 160 but is not attached to the primary leaf 150.

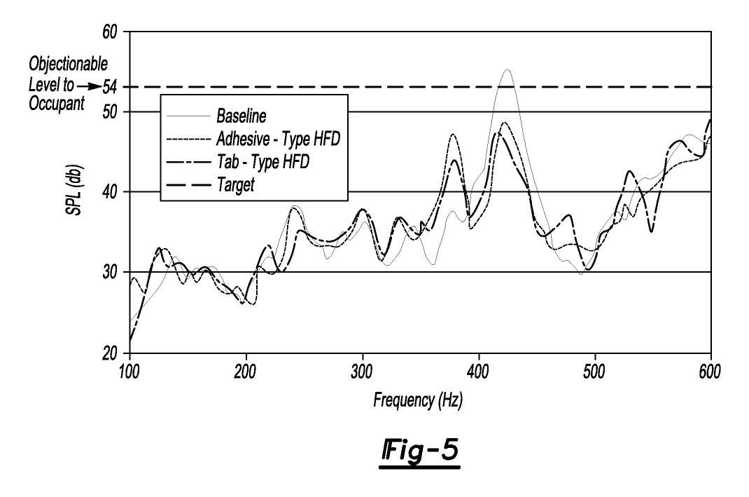

A comparison of high frequency vibration volumes for a vehicle with leaf springs that do have and do not have a high frequency dampener is shown in FIG. 5. The data shown in FIG. 5 was produced in a pickup truck which was traveling down a typical road at a speed of between 40-60 miles per hour. A target level or volume of 54 dB was established in that above 54 dB an individual was determined to be able to hear a high frequency vibration at approximately 410-420 Hz and below 54 dB an individual was determined not to be able to hear the high frequency vibration. Stated differently, 54 dB was determined to be the objectionable level for an occupant in the vehicle, however, other volume levels can be set or determined to be the objectionable level.

The solid line labeled “Baseline” illustrates the volume of the high frequency vibration that was determined and recorded at an occupant ear level within an interior of the truck. The dotted line labeled “Adhesive-Type HFD” illustrates the volume of the high frequency vibration using a high frequency dampener according to one aspect disclosed herein. The other dotted line labeled “Tab-Type HFD” illustrates a volume for the high frequency vibration using a high frequency dampener according to another aspect disclosed herein. As shown in FIG. 5, a significant reduction in the volume of the high frequency vibration was accomplished and a level that could not be heard at occupant ear level within the interior by an individual was provided. It is appreciated that the CV baseline data was obtained with a leaf spring that did have a tip liner insert, but did not have a high frequency dampener. Therefore, the data shown in FIG. 5 illustrates unexpected results provided by a simple and robust high frequency dampener.

It is appreciated that the high frequency dampener 196 can be made from any material known to those skilled in the art, illustratively including a polymer material and in some instances an oil-impregnated polymer material. As such, a simple, robust, and economically feasible solution to dampening high frequency vibration generated from a drivetrain of a motor vehicle is provided.

The above examples, aspects, embodiments, etc. are for illustrative purposes only and not intended to limit the scope of the invention in any way. Changes, modifications, etc. will occur to those skilled in the art and yet still fall within the scope of the invention disclosed herein. As such, it is the claims, and all equivalents thereof, which define the scope of the invention.

We claim:

1. A vehicle with a high frequency dampening leaf spring, said vehicle comprising:
an interior, a frame, a drivetrain and an axle, said interior, frame, drivetrain and axle mechanically coupled with each other and said drivetrain generating a high frequency vibration with a volume of greater than a target level within said interior during operation of the vehicle;
said axle mechanically coupled to said frame via a leaf spring, said leaf spring having a first leaf and a second leaf, said second leaf extending along and underneath said first leaf, said second leaf coupled to said first leaf via at least one leaf spring coupler, said leaf spring having a central location and being coupled to said axle at said central location;
a tip liner insert located between said first leaf and said second leaf; and
a high frequency dampener located between said first leaf and said second leaf, said high frequency dampener located outwardly from said tip liner insert such that said tip liner insert is located between said central location and said high frequency dampener;
said high frequency dampener reducing said volume of said high frequency vibration from greater than said target level to less than said target level in said interior during operation of the vehicle.

2. The vehicle of claim 1, wherein said first leaf and said second leaf each have a forward end and a rear end, said high frequency dampener located between said tip liner and said forward end of said first leaf and said second leaf.

3. The vehicle of claim 2, wherein said high frequency dampener is attached to said second leaf and not attached to said first leaf.

4-5. (canceled)

6. The vehicle of claim 1, wherein said high frequency dampener is made from a polymer.

7. The vehicle of claim 6, wherein said polymer is an oil-impregnated polymer.

8. The vehicle of claim 7, wherein said target level is 54 dB.

9. A leaf spring for a vehicle having a drivetrain that generates a high frequency vibration that is transmitted through an axle to a frame and into an interior of the vehicle with a volume greater than 54 dB during operation of the vehicle, said leaf spring comprising:
a primary leaf and a secondary leaf extending along and underneath said primary leaf, said primary leaf and said secondary leaf having a central location and being mechanically coupled to the axle at said central location;
a tip liner insert spaced part from said central location and located between said primary leaf and said secondary leaf; and
a high frequency dampener spaced apart from said tip liner insert and between said primary leaf and said secondary leaf, said tip liner insert located between said high frequency dampener and said central location;
said high frequency dampener reducing the volume of the high frequency vibration in the interior of the vehicle to less than 54 dB during operation of the vehicle.

10. The leaf spring of claim 9, wherein said primary leaf and said secondary leaf each have a front end, said high frequency dampener located between said primary leaf and said secondary leaf front ends and said tip liner insert.

11. The vehicle of claim 10, wherein said high frequency dampener is attached to said secondary leaf and not attached to said primary leaf.

12-13. (canceled)

14. The vehicle of claim 9, wherein said high frequency dampener is made from a polymer.

15. The vehicle of claim 14, wherein said polymer is an oil-impregnated polymer.
